(19) United States
(12) Patent Application Publication
(10) Pub. No.: US 2013/0297755 A1
(43) Pub. Date: Nov. 7, 2013

(54) NETWORK ELEMENT CONFIGURATION MANAGEMENT

(71) Applicant: Kaarle Eerik Ritvanen, Helsinki (FI)

(72) Inventor: Kaarle Eerik Ritvanen, Helsinki (FI)

(73) Assignee: NOKIA SIEMENS NETWORKS OY, Espoo (FI)

(21) Appl. No.: 13/988,371

(22) PCT Filed: Nov. 23, 2010
(86) PCT No.: PCT/EP10/67984

§ 371 Date: Jul. 24, 2013

(51) Int. Cl. H04L 12/24

(52) U.S. Cl. CPC H04L 41/085
USPC 709/220

(57) ABSTRACT

A method and apparatus for network element configuration management is disclosed. In the method the apparatus maintains configuration data on the network element. A set of configuration objects is created in the configuration data, wherein if a predetermined condition is satisfied, yet another configuration object is created in the configuration data. If said yet another configuration object satisfies said predetermined condition or another predetermined condition, one or more further configuration objects are created in the configuration data. Dependency information on the configuration objects satisfying said predetermined condition or said another predetermined condition and on the configuration objects created based on said predetermined condition or said another predetermined condition is stored in the configuration data.

### FIELD OF THE INVENTION

The exemplary and non-limiting embodiments of this invention relate generally to configuration management of a network element.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Configuration data of a network element (NE) may be modelled as a set of objects arranged into a tree-like hierarchy. An object may represent a physical or logical entity in NE, such as a hardware component, process, service, interface, address, or database. The nature of the represented entity is determined by class, which is a property of the object. Each object contains attribute definitions which characterize the particular entity the object represents. An attribute definition consists of the name of the attribute and the assigned value, specific to the object. The set of the attributes that must or may be used in connection with a specific object is determined by the class of the object. The tree-like hierarchy provides a means to denote simple ownership relations between the objects. More complex relationships may be modelled using reference-type attributes. The properties and mutual relationships of the object classes and attributes are described by NE-specific schema definitions. A configuration management system (CMS) may perform a wide variety of functions, e.g. ensure that the configuration data conforms to the schema, and store the configuration.

### BRIEF DESCRIPTION OF THE INVENTION

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented later.

According to an aspect of the present invention, there is provided a method for network element configuration management. In the method configuration data on the network element is maintained. A set of configuration objects is created in the configuration data, wherein if a predetermined condition is satisfied, yet another configuration object is created in the configuration data. If said yet another configuration object satisfies said predetermined condition or another predetermined condition, one or more further configuration objects are created in the configuration data. Dependency information is stored in the configuration data on the configuration objects satisfying said predetermined condition or said another predetermined condition and on the configuration objects created based on said predetermined condition or said another predetermined condition.

According to another aspect of the present invention, there is provided an apparatus for network element configuration management. The apparatus maintains configuration data on the network element, and creates a set of configuration objects in the configuration data, wherein, if a predetermined condition is satisfied, the apparatus is configured to create yet another configuration object in the configuration data.

If said yet another configuration object satisfies said predetermined condition or another predetermined condition, the apparatus is configured to create one or more further configuration objects in the configuration data. The apparatus is configured to store dependency information in the configuration data on the configuration objects satisfying the said predetermined condition or said another predetermined condition and on the configuration objects created based on said predetermined condition or said another predetermined condition.

### BRIEF DESCRIPTION OF THE DRAWINGS

In the following the invention will be described in greater detail by means of exemplary embodiments with reference to the accompanying drawings, in which

FIG. 1 shows a simplified block diagram illustrating an exemplary system architecture;

FIG. 2 illustrates apparatuses according to embodiments of the invention;

FIG. 3 is a signalling chart illustrating embodiments of the invention;

FIGS. 4 and 5 are flow charts illustrating embodiments of the invention;

FIGS. 6 and 7 illustrate dependencies affecting configuration management operations.

### DETAILED DESCRIPTION OF PREFERRED EMBODIMENTS

A configuration management system (CMS) provides an application programming interface (API) for reading and altering the configuration data at run-time. API may also provide a call-back mechanism allowing network element (NE) software to receive notifications on configuration changes. Moreover, the users of API are authenticated in order to provide access control to the configuration data according to access control lists (ACL). The network element may provide a command line interface and possibly a graphical user interface that allow human operators to view and alter the configuration data. Other interfaces may be provided as well on top of API.

Configuration management refers to a set of functions used to control the configuration of an apparatus or system. It may control the extension or reduction of the apparatus or system, the status of the constituent parts, and the identity of their allocation. A configuration manager (CM) entity allows the system to control operational parameters, including network element parameters and/or network element connection parameters.

Network element configuration management may rely on a data model and structure like the one described above. CMS may be based e.g. on a lightweight directory access protocol (LDAP); hence, the data model is derived from that of LDAP, which conforms to the description given above. Also extensible mark-up language (XML) documents may be seen as instances of this hierarchical data model, where objects are called elements. NETCONF protocol which describes a standard interface to NE configuration systems, uses an XML-based data model.

The Service Availability Forum (SAF) application interface specification (AIS) is an attempt to standardize the application interfaces provided by NE platforms. It also uses a hierarchical configuration object model conforming to the above description.

In many cases, there is no single representation of the NE configuration that would be optimal for all purposes. NE may have a default configuration preset at factory or at commissioning time. The NE operator may then alter the configuration by creating new objects, or by modifying or deleting existing objects. To keep the user interface simple from the operator's point of view, the object model may be adapted to describe the system at a relatively high level. However, from the application software point of view, it would be more convenient if CMS presented a detailed view of the system. Otherwise, the program code of the application has to make assumptions on the system and include an additional functionality for resolving the required details from the high-level view. This is increases overall complexity and decreases flexibility especially if several programs have to include a similar logic. If CMS is provided by a platform shared by multiple applications, this approach may also lead to hard-coding application-specific assumptions to the platform program code, which is highly undesirable.

CMS should provide a function that facilitates generating the detailed view from the high-level view. The process of producing a detailed configuration based on high-level definitions may be referred to as configuration expansion. A related challenge is the implementation of the inverse operation of configuration expansion. Original high-level definitions made by the operator may be interleaved and scattered across the entire configuration tree. Instead of a fully expanded configuration tree, the operator may prefer viewing the configuration as a series of high-level procedural operations resulting in the current configuration. Producing this view may be seen as an inverse function of configuration expansion, which may be referred to as configuration reduction. Configuration reduction allows the operator to view which configuration operations applied in the factory default state produce the current configuration. A third challenge is the validation of a configuration proposed by the operator. If the operator tries to alter the configuration in a way that NE does not support or that is semantically incorrect, it should be possible to decline the operation.

Yet a fourth challenge is related to the upgrade of the schema. In such a case, NE should not fall back to the default configuration but rather convert the existing configuration to comply with the new version of the schema. The NETCONF specification suggests the use of extensible style-sheet language transformations (XSLT) as a possible technique for generating detailed configurations from high-level descriptions. However, it is a tedious task to produce the required style-sheets in practice. Moreover, XSLT is impractical in cases where the operator alters a small portion of a large configuration. A change in the high-level view may imply various changes across the whole configuration tree, and XSLT provides no efficient way for propagating the changes to the required locations.

Practical CMSs may address this problem by isolating the functionality responsible for expansion from the actual application program code, eliminating the need for redundant code in applications. This may be implemented such that CMS allows schema-specific plug-ins to induce further operations into the change transaction based on the operator's actions. A variation of this is to disallow direct operations on the configuration data but provide dedicated schema-specific tools which expand the operator's requests into detailed configuration data.

When a configuration object is instantiated under configuration expansion scheme, some of its attributes may be set according to the object's prototype. In some cases, subordinate objects are also created based on the main object's prototype. The prototype is a high-level property of the object and distinct from the object's class. The prototype definition contains detailed information on objects of that type, which is then copied to the object instance.

The prototype-based approach may be used in some configuration tools. In some cases, this concept may be enhanced by allowing multiple inheritance among prototype definitions. Even though prior art manages to eliminate redundancy from the application program code by isolating the expansion functionality, the fact that there is much redundancy between the schema-specific plug-ins or tools themselves remains largely unaddressed. CMSs may lose the knowledge of which parts of the configuration data are original and which were created by expansion. This implies that they do not implement a generic configuration reduction function, thus leaving two options:
CMS does not implement configuration reduction at all, but only provides the operator with a detailed view, which is inconvenient.
CMS allows implementation of schema-specific configuration reduction function. This does not scale well because the function has to be updated along with the schema.

Some CMSs try to tackle this problem by maintaining logs where they record all configuration commands the operator has executed after commissioning. Even though this indeed produces a series of commands that can be used to reconstruct the current configuration, this is not equivalent to configuration reduction. Under this scheme, the length of the log is an increasing function of the NE's lifetime rather than being proportional to the actual complexity of the current configuration. Such logs may become unreadable by humans if the configuration is modified frequently. CMS may automatically perform simple validation operations on configuration attributes based on schema definitions. The simple type concept of XML schema is a possible way to express such simple constraints.

For semantic validation and integrity checking, the solutions may be similar to what is used for configuration expansion: use of schema-specific plug-ins or configuration tools.

Again, this leads to redundancy between such plug-ins and tools. In CMSs, upgrading the schema at run-time may require applying schema version-specific conversion programs on the configuration data. Maintaining such programs may be a tedious task in the long run.

The conversion programs are simpler and less frequently needed, if it is possible to perform a configuration reduction, i.e. extract the original high-level definitions from the detailed configuration. Conversion programs operating on the high-level definitions are simpler than those operating directly on the detailed configuration. After conversion, the high-level definitions may again be expanded to the detailed configuration, according to the upgraded schema. It may only be the detailed view that is changing or being complemented. In such cases, schema-specific conversions are not needed at all if configuration reduction is available. Also a command log approach may be used to facilitate schema upgrades, but it may introduce unnecessary complexity to the conversion programs. Moreover, the execution time of the conversion programs may increase as a function of the NE's lifetime, along with the length of the command log.

Modern relational databases based on a structured query language (SQL) provide solutions to problems similar to configuration expansion and validation. The SQL language allows definition of triggers, assertions, and referential integrity constraints as part of the schema description, providing a higher level programming interface than CMSs typically do. CMSs may not necessarily utilize SQL as such because a relational data model is not necessarily suitable for modelling configuration data for practical applications. In many cases, a hierarchical model is more desirable. The solution suggested by an exemplary embodiment is advantageous over SQL.

Exemplary embodiments of the present solution will now be described more fully hereinafter with reference to the accompanying drawings, in which some, but not all embodiments of the present solution are shown. Indeed, the present solution may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present solution are applicable to any communication device, network element, user equipment, server, corresponding component, and/or to any communication system or any combination of different communication systems providing network element configuration management. The communication system may be a wireless communication system or a communication system utilizing both fixed networks and wireless networks. The protocols used and the specifications of communication systems, devices and network elements, especially in wireless communication, develop rapidly. Such development may require extra changes to an embodiment. Therefore, all words and expressions should be interpreted broadly and are intended to illustrate, not to restrict, the embodiment.

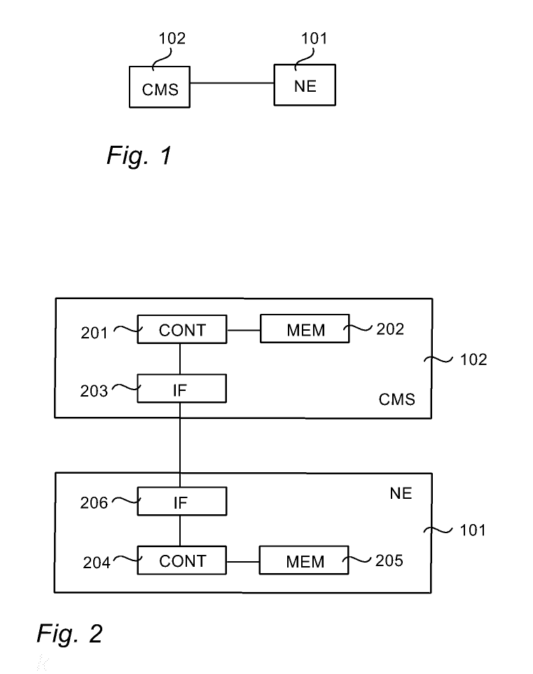

In the following, different embodiments will be described using, as an example of a system architecture to which the embodiments may be applied, an architecture based on the third-generation wireless communication system UMTS (universal mobile telecommunication system) without restricting the embodiment to such an architecture, however. A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements, and protocols used in or for group communication are irrelevant to the actual invention. Therefore, they need not be discussed in more detail here.

FIG. 1 shows a network element 101 such as a base station (BS, Node B), base station controller (BSC), home location register (HLR), mobile switching centre (MSC), a media gateway (MGW), a radio network controller (RNC), a visitor location register (VLR), a transcoding rate adaptation unit (TRAU), a serving GPRS (general packet radio service) support node (SGSN), or a home node B gateway (HNB-GW), mobility management entity and enhanced packet core gateway (MME/EPC-GW), or any other network element of a communications system. The network element is connected to a configuration management device 102. FIG. 1 only illustrates a simplified example. In practice, the network may include more network element and devices. It should be appreciated that the network element and the configuration management device may also be connectable to each via one or more further devices (not shown in the Figure). It should be appreciated that the configuration management device 102 may also be an integral part of the network element 101. The embodiments are not, however, restricted to the network given above as an example, but a person skilled in the art may apply the solution to other communication networks provided with the necessary properties.

FIG. 2 illustrates examples of apparatuses according to embodiments of the invention. FIG. 2 shows a configuration management device 102 configured to be in a connection with a network element 101. The configuration management device 102 comprises a controller 201 operationally connected to a memory 202 and to an interface 203. The controller 201 controls the operation of the device. The memory 202 is configured to store software and data. The interface 203 is configured to setup and maintain the connection with the network element 101.

The network element 101 comprises a controller 204 operationally connected to a memory 205 and an interface 206. The controller 204 controls the operation of the network element. The memory 205 is configured to store software and data. The interface 206 is configured to setup and maintain the connection with the configuration management device 102. In an embodiment, the network element is connected to the configuration management device via another device.

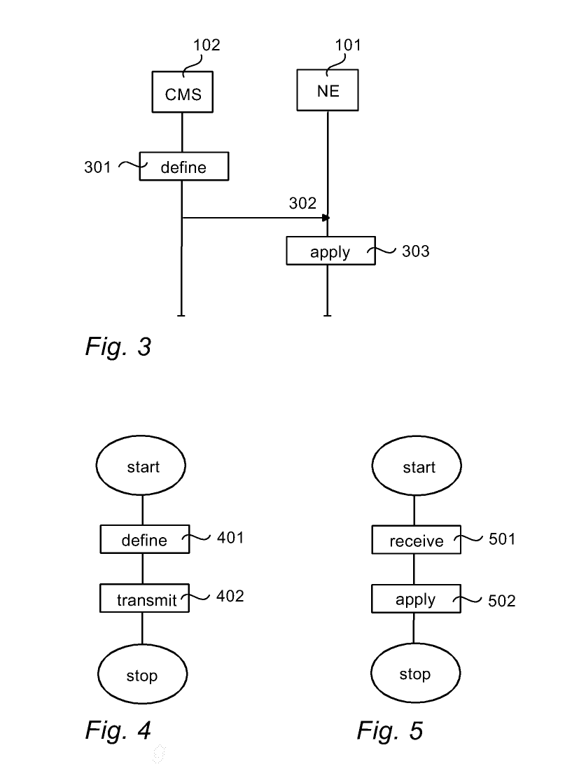

In an embodiment, the configuration management device may define network element configuration parameter and provide the configuration parameter to the network element. The signalling chart of FIG. 3 illustrates the required signalling. In the example of FIG. 3, the configuration management device 102 defines 301 the network element configuration parameter and transmits 302 the configuration parameter to the network element 101. The configuration management device 102 and the network element 101 may then apply 303 the parameter. Alternatively, the configuration data may be transmitted to the network element 101 such that the network element 101 initiates a query to which the configuration management device 102 responds.

FIG. 4 is a flow chart illustrating a non-limiting embodiment of the invention. In step 401, the configuration management device defines a network element configuration parameter. In step 402, the configuration management device transmits the parameter to the network element.

Alternatively, the configuration data may be transmitted to the network element such that the network element initiates a query to which the configuration management device responds.

FIG. 5 is a flow chart illustrating a non-limiting embodiment of the invention from the network element's point of view. In step 501, the network element receives a network element configuration parameter from the configuration management device. In step 502, the network element applies the configuration parameter. Alternatively, the configuration data may be transmitted to the network element such that the network element initiates a query to which the configuration management device responds.

In exemplary embodiment the configuration management device utilizes a generalized prototype system with multiple inheritance, allowing the configuration expansion and integrity checking logic to be expressed using special-purpose declarations in the prototype definitions, thus eliminating the need for partially redundant schema-specific program logic. It also employs a versatile dependency tracking system in order to automatically provide referential integrity checking, garbage collection, and configuration reduction. The data model conforms to what was described above. Objects have unique path names determining their position in the configuration data. In this system, even the attributes, references, and assigned values thereof may be represented as objects in the configuration data, having uniform path names with the other objects. As regards the assigned values of attributes and references, they are encoded in the name of the value objects. There may also be other types of special objects, namely sets and containers. A term “instance” may be used to refer to objects representing instances of object classes, whereas “object” may refer to any entity having a unique path name.

The object class and prototype definitions may be combined into single entities. The definition of an object class includes:
A name uniquely indentifying the object class.
Declarations of subordinate objects.
An ordered list of implied object declarations. These declarations allow automatic creation of additional configuration objects, i.e. configuration expansion.
References to inherited object class definitions, i.e. super-classes. When processing the class definition, the subordinate and implied object declarations are recursively imported from each super-class. When a subordinate with a specific name is defined by multiple classes, the definitions are compatible definitions.
Flag indicating whether the class is abstract, meaning that it cannot be instantiated but only inherited.

When an instance is created, it is assigned one primary object class. The object is said to be an instance of that class and also of the direct and indirect super-classes of that class. Each instance has a special multi-value attribute named .instanceof that indicates the classes the object is considered an instance of. The primary object class cannot be changed after object instantiation. A subordinate object declaration includes the name of the object and the type of the object, which may be one of the following:
Attribute. Attribute may be mandatory or optional, and may allow assignment of one or multiple values. A default value may also be specified.
Instance of a specified object class.
Reference to an instance or multiple instances of a specified object class.
Set of instances of a specified object class.
Container object that groups further attributes, instances, references, sets, and containers together.

Attribute, reference, set, and container subordinates are created automatically with the instance object. Instance subordinates are not automatically created with the instance object, but they may be created by implied object declarations if desired. The implied object declarations may assign values to attributes and references by creating value assignment objects. They may also create rules. The object class definitions are considered static between software upgrades. References are attributes, the value of which is a path name of another object in the configuration data. There are some additional properties that may be defined for references:
Class of the referenced object. The object is an instance of the specified object class.
Scope of the reference. The referenced object is located in the sub-tree specified by this path name. Hence, the path encoded to the assignment object's name may be relative to the scope of the reference. The path name may be absolute or relative to the object housing the reference. The path name may be indirect, in which case the scope may depend on the assignments of other references.
Flag indicating whether this is a binding reference. A binding reference prevents deletion of the reference target unless the reference assignment is itself deleted in the same transaction. Non-binding references are automatically deleted along with the target object.
Reciprocal reference. This is an optional property referring to a reference defined by the referenced object class. This allows automatic creation of bi-directional references.

A path name is a sequence of object names indicating an object's position in the configuration data. An absolute path name indicates the position relative to the root object. An object may be uniquely identified by its absolute path name.

A relative path name indicates the position relative to another object. Path name resolution is a recursive operation that determines the object the path name refers to. Path name resolution starts from the object to which the path is relative. The resolution algorithm reads the first component from the path name. The component may refer to a subordinate of the current object. For the next round, that object becomes the current object while the first component is removed from the path. Resolution ends when each of the path components have been processed, and the last current object becomes the primary result of the resolution. However, a component may also be one of the following special symbols:
. refers to the current object itself.
.. refers to the superior of the current object.
. . . refers to the referenced object when the current object is a single-value reference having an assigned value.

Following the reference in this way is called dereferencing. Resolution fails if a path component refers to a non-existent object. A path name containing at least one . . . component is an indirect path name. Other path names are direct path names. In addition to the resolved object, a successful path name resolution also produces a secondary result: a list of the objects traversed during the resolution. This result is used by the object creation operation. As regards indirect paths, also the value assignment objects of the de-referenced single-value references are included in the list of traversed objects.

Regarding transaction models, grouping multiple modification operations into transactions is supported. API and the user interface provide means for starting, committing and cancelling a transaction, and issuing query and modification operations in the context of a transaction. Transactions are atomic and isolated from other operations. The intermediate states of an uncommitted transaction are not visible outside the transaction, and operations initiated outside the transaction cannot interfere with it. Nested transactions are supported, meaning that a transaction can contain operations that are themselves transactions consisting of multiple operations. Transactions may be implemented e.g. as structures that contain
A reference to the database or nesting transaction and
Lists of objects that have been created, deleted, or the dependencies of which have changed.

In addition, various indices can be used to optimize performance. Modification operations merely modify the object lists, and they are propagated to the database or nesting transaction at the commit phase. Query operations first check the state of the queried object from these lists. If the object has not been touched in the transaction, the query is forwarded to the database or nesting transaction. Before propagating the changes to the database or nesting transaction, the commit operation processes rules for the newly created objects. After processing of rules, CMS may carry out some validity checking, e.g. whether all mandatory attributes and references have been assigned and whether the attribute assignments are semantically correct. This is done to ensure the consistency of the transaction. Dependency tracking and rule processing also have roles in ensuring consistency. The solution outlined above provides atomicity, consistency, and isolation for transactions, provided that only one transaction at a time is allowed to do modifications. There are techniques that allow relaxing this limitation, and those may be used in the embodiment.

An object dependency tracking system may be employed. In this embodiment, a dependency is a directional relationship between two configuration objects, called the subject and the object of the dependency. The subject is said to hold a dependency to the object. Dependencies are created automatically by CMS as explained later, and are not exposed via external interfaces. There are four types of dependencies:
DEPENDS_ON: This dependency implies that the subject is deleted when the object is deleted at the latest. Each configuration object holds this kind of dependency at least to its superior object in the configuration data.
USES: This dependency justifies the existence of the object and prevents its deletion by automatic garbage collection as long as the subject exists.
REQUIRES: This dependency prevents deletion of the object unless the subject is deleted in the same transaction.
EXPORTS: This dependency indicates that the object has been created explicitly by the operator, i.e. is part of the high-level configuration. The subject is the root object. This dependency only exists with a corresponding USES dependency.

The existence of EXPORTS dependencies makes it possible to deduce which objects are part of the high-level configuration, and thus enables implementation of configuration reduction. The other dependencies allow deducing the order in which the high-level configuration objects should be created if a similar configuration was created from scratch.

Garbage collection may be implemented based on the object dependencies. A configuration object is automatically deleted when it is not possible to reach the configuration object by following the USES dependencies from the root object, or when the object of any DEPENDS_ON dependency of the configuration object is deleted. The root object itself is never deleted.

The deletion algorithm may detect cyclic dependencies between objects. The dependency tracking and garbage collection systems facilitate the implementation of a generic object deletion operation.

Operations on configuration objects involve the object-specific modification operations provided by CMS. These operations are atomic, i.e. carried out within a single transaction. They either succeed or are completely rolled back upon failure. If a modification operation is executed within a transaction containing other operations, CMS internally creates a nested transaction for it.

The object creation operation requires the path of the new object as input. That may be split to the path of the superior object and the name of the target object. The creation operation determines the type of the new object from the subordinate declarations in the class definition of the superior object. The type may be instance, attribute or reference value assignment, or rule. Creation of an attribute assignment is a relatively simple operation, whereas the other cases are more complex.

Regarding creating an instance, in CMSs, the instance object creation operation may need an object class-specific part to perform configuration expansion. In an embodiment, the required actions are encoded by the object class definitions, allowing a fully generic implementation. The primary object class may be given as input to the object creation operation.

If omitted, the object class is the one specified by the class definition of the superior object. In any case, the object is an instance of that class. The implied object declarations of the primary object class and its super-classes are processed. Each declaration essentially describes the inputs to a single object creation operation, which is carried out within the same transaction. The path of the implied object may be absolute or relative to the implying object. Also indirect paths are allowed. The following dependencies are created, the implying object being the subject:
REQUIRES dependency to each object traversed when resolving the path given in the implied object declaration; the resolution is done according to an algorithm, up to the superior of the implied object to be created,
REQUIRES dependency to the implied object, and
USES dependency to the implied object.

These dependencies prevent the premature deletion of the implied object. In case an indirect path is used, the dependencies to the traversed objects prevent changes to those single-value reference assignments that determined the absolute location of the implied object. The processing order of the implied object declarations is deterministic. The declarations taken from a specific object class definition are processed in the same order as they appear in the definition. They are not processed until the declarations of all super-classes have been processed. In addition to the object class, it is possible to provide instance-specific attribute assignments as arguments to the creation operation. The attribute assignment objects are created after processing of the implied object declarations, within the same transaction. At this point, also default value assignments are created for the relevant attributes. If any attribute assignment objects were created when processing an implied object declaration, they are objects of similar REQUIRES and USES dependencies as the main object.

Reference assignment takes a direct path to the target object as input. The path may be absolute, relative to the object containing the reference, or relative to the scope of the reference. The referenced object satisfies the class and scope restrictions specified by the reference definition. The assignment procedure includes resolving the scope of the reference defined by the object class. For each object traversed during the resolution, a DEPENDS_ON dependency is created, the subject being the new reference assignment object. In case of a binding reference, REQUIRES dependencies are created instead. The assignment object holds a similar dependency also to the target object. These dependencies ensure that when the target object or any reference affecting the scope (potentially expressed using an indirect path) is about to change or disappear, either
the affected reference assignment is deleted, or
the operation is prevented in case of a binding reference.

Reference assignment potentially results in creation of a reciprocal reference assignment from the target object to the referencing instance object if a reciprocal reference is defined by the object class. In this case, a USES dependency is created between the reference assignments, the object being the implied reciprocal reference, in order to conjoin their life spans.

The creation operation is slightly different when invoked by the operator or as a result of implied object list or rule processing (implicit and explicit objects). If an object is created explicitly by the operator, USES and EXPORTS dependencies are created for it, the subject being the root object, marking the object to belong to the high-level configuration. This is also done to any attribute assignment object created for the main (instance) object.

If the operator attempts to create an object that already exists, the operation fails. If the creation of a pre-existing object is attempted due to an implied object definition or rule, the operation does not necessarily fail.

If the existing object is an instance of the requested object class, and there are no conflicting (single-value) attribute or reference assignments, the operation succeeds. The missing attribute and reference assignments are created, and the dependencies related to these and pre-existing objects are created as if the object did not exist before the operation.

In CMSs, the deletion operation may need an object class-specific part to handle referential integrity checking and potentially deletion of some related objects. In an embodiment, the required actions are encoded by the dependency data, allowing a fully generic implementation. The deletion operation is allowed only on objects of an EXPORTS dependency, i.e. high-level configuration objects. When such an object is deleted, a garbage collection procedure is triggered, resulting in deletion of further objects. The deletion request is declined if there is at least one REQUIRES dependency wherein the object would be deleted in the transaction but the subject would not. A deletion request can be declined also for other reasons, e.g. if it is applied to an assignment of a mandatory attribute.

A flush operation deletes all subordinate objects of the target object in a single transaction. All subordinate objects must be objects of EXPORT dependencies.

A set operation is applicable to attribute and reference objects. It flushes the target object and creates one or more value assignment objects under the target object according to the input. No validity checking is performed in any intermediate state of the set operation, allowing re-assignment also for mandatory attributes and references.

Implied object declarations make it possible to automatically create related objects upon object instantiation, without any additional program code. Rules add even more flexibility to the configuration management device, allowing implied object declarations to
depend on other objects, including attribute and reference assignments
be processed in future when some specified conditions are met, and
place integrity constraints on database objects.

A rule refers to a named object that is placed under a special set named .rule under the object owning the rule. The scope of the rule is limited to the sub-tree starting from the owning object. A rule object contains the following subordinates:
Set of object selectors. A selector consists of a name and a pattern, against which object paths are matched. The pattern may be implemented e.g. as a regular expression (regex), or based on an XPath syntax (especially in the case of XML document applications). The object paths are relative to the owning object. An object matching the pattern yields variables for the absolute and relative object paths, and potentially for the regex group matches. These variables may be accessed by formula, condition, and assertion expressions, as well as by object declarations. A rule has at least one selector.
Set of formulae. A formula consists of a name and an expression yielding a string-type variable that may be accessed by condition and assertion expressions, and by object rules.
Condition. A Boolean expression specifying whether the rule is valid for a set of selected objects. The expression may contain references to selector and formula variables. If omitted, tautology is assumed.
Assertion. A Boolean expression that, when defined, yields the value of true for all sets of matched objects satisfying the condition.
Set of implied object declarations. The declarations may contain references to object selector and formula variables. Individual declarations have also names which indicate their mutual processing order.

As the rules and components thereof are objects, they may be created by implied object declarations of other objects. Once a rule has been created, it may be extended by creating more implied object declarations thereunder. Rules are not necessarily created or extended explicitly but only via implied object declarations. Rules and extensions thereof are deleted by the normal garbage collection mechanism as the other implicit objects. One implementation alternative is to store the formula, condition, and assertion expressions directly as concrete syntax trees under the related object. This makes it possible to use extensible assertion expressions, since existing syntax trees may be augmented by declarations of new objects. CMS provides a language for defining selector patterns, and primitive functions to be used in expressions. In order to add flexibility, CMS may support e.g. definition of
derived functions by constructing syntax trees to a special location, to be used in expressions, and
custom primitives and object selectors in a generic programming language.

In order to optimize the performance of CMS, the following constraints are imposed, even though they are not necessary from the paradigm point of view:

1. No new selectors or formulae can be created after creation of the rule.

2. The formula and condition expressions are not extensible (only assertion expressions are.)

3. An expression may depend on the database state only via the selector variables and static properties of the owning object, i.e. its path and class.

These constraints significantly reduce the need to re-evaluate the expressions on database updates. Specifically, constraint 3 implies that deletions may be done without re-evaluating any expression. An exception is the case where an assertion expression is altered due to a partial deletion of its syntax tree, in which case that particular expression has to be re-evaluated.

When a rule is created for an object, its prevailing subordinate objects are matched against each selector of the rule. For each match, a special match object is created under the selector object. The match object stores each variable assignment related to the match. A DEPENDS_ON dependency is created between the match object and the matching object, the former being the subject. When a match object is created under a selector, a Cartesian product is calculated from the match object sets of every other selector of the rule. Each member of the product set is a vector of match objects and is processed as follows:

1. Combine the variable assignments of all match objects of the vector with each other and with the assignments of the newly created match object.

2. Evaluate the formula expressions, substituting the assigned values for selector variable references. This generates additional variable assignments.

3. Evaluate the condition expression, substituting the assigned values for selector and formula variable references. If false, stop processing this vector.

4. Create a group match object under the rule object. The group match object stores the combined variable assignments and those generated by the formulae. For each match object of the vector, a DEPENDS_ON dependency is created, the group match object being the subject.

5. Evaluate the assertion expression, substituting the assigned values for selector and formula variable references. If false, fail the transaction.

6. Process the implied object declarations of the rule, substituting the assigned values for variable references. The procedure is similar as when instantiating objects.

Additionally, a special group match specific object is created under the declaration object. This object holds a DEPENDS_ON dependency to the group match object, and REQUIRES and USES dependencies to the implied object, and potentially to the related attribute and reference assignments. Note that the implied objects may themselves also be rules or components thereof.

When a (non-rule) object is created, the new object is matched against the existing rules of its direct and indirect superior objects in a similar way as is done when creating a new rule. The processing starts from the rules of the direct superior and continue toward the root. Rules at the same level are processed in the order indicated by their names. As a result of this processing, new implied objects will potentially be created. When the assertion syntax tree of a rule is altered due to component creation or deletion, the expression is re-evaluated for all existing group match objects of the rule (according to the variable assignments they store). The transaction fails if the assertion evaluates to false for any group match. When a rule is extended by adding a new implied object declaration, the new declaration is processed according to step 6 of the above sequence. This procedure is carried out for all existing group match objects of the rule. The dependencies set up during the processing ensure that implied objects will automatically be deleted when the conditions which triggered their creation are no longer met.

There are two possible approaches as regards the rule processing order, leading to slightly different semantics. In the first alternative, the rule is processed immediately after it has been created, extended, or a potentially matching object has been created. As processing the rule may result in creation of further objects, it becomes a recursive operation. A nested transaction may be created for each recursion level. The second alternative postpones the rule processing to the end of the transaction. The implementation maintains a list of the objects that were created within the transaction, the elements of which are processed at the commit phase in the order of creation. The implied objects created by the rules are inserted to the end of the object list. Rule processing is complete when the list is exhausted. The latter alternative is considered more flexible from rule definition point of view.

Following listings illustrate the capabilities of an exemplary configuration management device by a few examples related to configuration data, and background information on high availability services (e.g. HAS, CLM, AMF) and its configuration.

Listing 1 illustrates what object class definitions may look like. The class fs.ha.node.supervised inherits class fs.ha.node.managed and introduces an additional set-type subordinate for recovery unit (fs.ha.ru) objects. The recovery unit (which may also be referred to as a service unit) class contains a reference subordinate, pointing to a recovery group (which may also be referred to as a service group) (fs.ha.rg) instance in sub-tree ha rg. (The space character is used as the path delimiter in these examples). This reference features also a reciprocal reference definition, referring to the multi-value reference named ru in the recovery group object class. Listing 1 presents example object class definitions:

class fs.ha.node.supervised {

inherits fs.ha.node.managed;
set ru { type fs.ha.ru; }

}
class fs.ha.ru {

reference rg {

type fs.ha.rg;
scope ha rg;
backref ru;

}
set process { type fs.ha.process; }
string control-script;
...

}
class fs.ha.rg {

reference ru {

type fs.ha.ru;
multivalue;
scope ha;
backref rg;

}
...

}

Listing 2 demonstrates simple implied object definitions. Besides inheriting the recovery unit base class, the recovery unit of type FooServer (fs.ha.ru.FooServer) automatically creates two subordinates for itself and assigns a value for the control-script attribute. A path name prefixed with the .component (e.g. .process Foo) is interpreted as relative to the instance object. Listing 2 presents an example recovery unit type definition:

class fs.ha.ru.FooServer {

inherits fs.ha.ru;
imply . process Foo { type fs.ha.process.Foo; }
imply . process Bar { type fs.ha.process.Bar; }
imply . control-script \

/opt/nokiasiemens/SS_Foo/script/FooServerControl.sh

}

Listing 3 lists the objects of the sub-tree ha node CLA-0 of an example database. Assume the operator issues a command intending to create object ha node CLA-0 ru FooServer of type fs.ha.ru.FooServer, while the definition of Listing 2 is in effect. Listing 4 (see later in the description) shows the sub-tree after the operation, the created objects being marked in italics. The information provided in the creation command is marked in boldface. The rest of the objects are created based on the object class definition. Listing 3 presents a portion of an example database:

ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed
ha node CLA-0 .instanceof fs.ha.node.supervised
ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \

fs.ha.process

ha node CLA-0 ru DirectoryServer process LDAPServer
.instanceof \

fs.ha.process.LDAPServer

ha node CLA-0 ru DirectoryServer process LDAPServer .rule
ha node CLA-0 ru DirectoryServer rg
ha node CLA-0 ru DirectoryServer rg Directory

Currently, the definition of a cluster configuration is not a straightforward task. This task may be simplified by implementing a feature management system where only high-level features is enabled, possibly supplying them some parameters, and configuration objects representing recovery groups, recovery units, processes, and storage devices would be created automatically based on the selected features. In practice, this requires that the feature definitions contain information on the managed objects they need.

Let us assume that feature Foo requires a FooServer recovery unit to be deployed on all supervised nodes. These recovery units shall belong to a non-redundant recovery group Foo.

Listing 5 shows the definition of the feature Foo. Instantiation of that class results in creation of a rule named feature-Foo, against which objects in the ha node subtree are matched. The rule causes a FooServer recovery unit to be created under each present and future subordinate of type fs.ha.node.supervised, and assigning the rg reference to object ha rg Foo. The path is considered relative to the scope of the reference (i.e. Foo refers to ha rg Foo).

Listing 5 presents an example feature definition:

class fs.feature.Foo {

inherits fs.feature;
imply ha node .rule feature-Foo {

selector n { pattern “([\hat{ } ]+) .instanceof

fs.ha.supervised”; }

imply ha rg Foo { type ha.rg.Foo; }
imply “. {n_1} ru FooServer” {

type fs.ha.ru.FooServer;
rg Foo;

}

}

}
class fs.feature.root {

inherits fs.feature;
fs.feature.Foo Foo;
...

}

The corresponding reciprocal reference is also assigned, and the implied object declarations shown in Listing 2 are processed. This is illustrated by the initial database shown in Listing 6, which transforms into the state shown in Listing 7 when the operator creates the object feature Foo. The operator does not have to provide the object class (fs.feature.Foo) because it is defined by the class of the superior object (fs.feature.root). The objects marked in boldface italics match the selector of the rule (regex ([̂ ]+).instanceof fs.ha.node.supervised), resulting in creation of match objects, shown underlined in italics in the listing. In these examples, the names of the match objects are integers. The values have no special meaning, but basically are just unique identifiers. Listing 6 presents an example database:

.rule
feature
feature .instanceof
feature .instanceof fs.feature
feature .instanceof fs.feature.root
feature .rule
ha
ha .rule
ha node
ha node .rule
ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed
ha node CLA-0 .instanceof fs.ha.node.supervised
ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \

fs.ha.process

ha node CLA-0 ru DirectoryServer process LDAPServer
.instanceof \

fs.ha.process.LDAPServer

ha node CLA-0 ru DirectoryServer process LDAPServer .rule
ha node CLA-0 ru DirectoryServer rg
ha node CLA-0 ru DirectoryServer rg Directory
ha node CLA-1
ha node CLA-1 .instanceof
ha node CLA-1 .instanceof fs.ha.node
ha node CLA-1 .instanceof fs.ha.node.cla
ha node CLA-1 .instanceof fs.ha.node.managed
ha node CLA-1 .instanceof fs.ha.node.supervised
ha node CLA-1 .rule
ha node CLA-1 ru
ha node CLA-1 ru .rule
ha node CLA-1 ru DirectoryServer
ha node CLA-1 ru DirectoryServer .instanceof
ha node CLA-1 ru DirectoryServer .instanceof fs.ha.ru
ha node CLA-1 ru DirectoryServer .instanceof
fs.ha.ru.DirectoryServer
ha node CLA-1 ru DirectoryServer .rule
ha node CLA-1 ru DirectoryServer control-script
ha node CLA-1 ru DirectoryServer process
ha node CLA-1 ru DirectoryServer process .rule
ha node CLA-1 ru DirectoryServer process LDAPServer
ha node CLA-1 ru DirectoryServer process LDAPServer
.instanceof
ha node CLA-1 ru DirectoryServer process LDAPServer
.instanceof \

fs.ha.process

ha node CLA-1 ru DirectoryServer process LDAPServer
.instanceof \

fs.ha.process.LDAPServer

ha node CLA-1 ru DirectoryServer process LDAPServer .rule
ha node CLA-1 ru DirectoryServer rg
ha node CLA-1 ru DirectoryServer rg Directory
ha rg
ha rg .rule
ha rg Directory
ha rg Directory .instanceof
ha rg Directory .instanceof fs.ha.rg
ha rg Directory .instanceof fs.ha.rg.Directory
ha rg Directory .instanceof fs.ha.rg.activestdby
ha rg Directory .instanceof fs.ha.rg.coldactivestdby
ha rg Directory .rule
ha rg Directory ru
ha rg Directory ru node CLA-0 ru DirectoryServer
ha rg Directory ru node CLA-1 ru DirectoryServer

Listing 7 demonstrates how the database in Listing 6 is updated upon object creation (while the definition of Listing is in effect):

.rule
feature
feature .instanceof
feature .instanceof fs.feature
feature .instanceof fs.feature.root
feature .rule
feature Foo
feature Foo .instanceof
feature Foo .instanceof fs.feature
feature Foo .instanceof fs.feature.Foo
feature Foo .rule
ha
ha .rule
ha node
ha node .rule
ha node .rule feature-Foo
ha node .rule feature-Foo .match
ha node .rule feature-Foo .match 1
ha node .rule feature-Foo .match 3
ha node .rule feature-Foo imply
ha node .rule feature-Foo imply 0
ha node .rule feature-Foo imply 0 .match
ha node .rule feature-Foo imply 0 .match 4
ha node .rule feature-Foo imply 0 .match 5
ha node .rule feature-Foo imply 0 object
ha node .rule feature-Foo imply 0 object Foo type
fs.ha.rg.Foo
ha node .rule feature-Foo imply 0 target
ha node .rule feature-Foo imply 0 target ha rg
ha node .rule feature-Foo imply 1
ha node .rule feature-Foo imply 1 .match
ha node .rule feature-Foo imply 1 .match 6
ha node .rule feature-Foo imply 1 .match 7
ha node .rule feature-Foo imply 1 object
ha node .rule feature-Foo imply 1 object FooServer type \

fs.ha.ru.FooServer rg Foo

ha node .rule feature-Foo imply 1 target
ha node .rule feature-Foo imply 1 target . {n_1} ru
ha node .rule feature-Foo selector
ha node .rule feature-Foo selector n
ha node .rule feature-Foo selector n .match
ha node .rule feature-Foo selector n .match 0
ha node .rule feature-Foo selector n .match 2
ha node .rule feature-Foo selector n pattern
ha node .rule feature-Foo selector n pattern ([\hat{ }]+)
.instanceof \

fs.ha.node.supervised

ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed

[symbol]

ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \

fs.ha.process

ha node CLA-0 ru DirectoryServer process LDAPServer
.instanceof \

fs.ha.process.LDAPServer

ha node CLA-0 ru DirectoryServer process LDAPServer .rule
ha node CLA-0 ru DirectoryServer rg
ha node CLA-0 ru DirectoryServer rg Directory
ha node CLA-0 ru FooServer
ha node CLA-0 ru FooServer .instanceof
ha node CLA-0 ru FooServer .instanceof fs.ha.ru
ha node CLA-0 ru FooServer .instanceof fs.ha.ru.FooServer
ha node CLA-0 ru FooServer .rule
ha node CLA-0 ru FooServer control-script
ha node CLA-0 ru FooServer control-script \

/opt/nokiasiemens/SS_Foo/script/FooServerControl.sh

ha node CLA-0 ru FooServer process
ha node CLA-0 ru FooServer process .rule
ha node CLA-0 ru FooServer process Bar
ha node CLA-0 ru FooServer process Bar .instanceof
ha node CLA-0 ru FooServer process Bar .instanceof
fs.ha.process
ha node CLA-0 ru FooServer process Bar .instanceof
fs.ha.process.Bar
ha node CLA-0 ru FooServer process Bar .rule
ha node CLA-0 ru FooServer process Foo
ha node CLA-0 ru FooServer process Foo .instanceof
ha node CLA-0 ru FooServer process Foo .instanceof
fs.ha.process
ha node CLA-0 ru FooServer process Foo .instanceof
fs.ha.process.Foo
ha node CLA-0 ru FooServer process Foo .rule
ha node CLA-0 ru FooServer rg
ha node CLA-0 ru FooServer rg Foo
ha node CLA-1
ha node CLA-1 .instanceof
ha node CLA-1 .instanceof fs.ha.node
ha node CLA-1 .instanceof fs.ha.node.cla
ha node CLA-1 .instanceof fs.ha.node.managed

[symbol]

ha node CLA-1 .rule
ha node CLA-1 ru
ha node CLA-1 ru .rule
ha node CLA-1 ru DirectoryServer
ha node CLA-1 ru DirectoryServer .instanceof
ha node CLA-1 ru DirectoryServer .instanceof fs.ha.ru
ha node CLA-1 ru DirectoryServer .instanceof
fs.ha.ru.DirectoryServer
ha node CLA-1 ru DirectoryServer .rule
ha node CLA-1 ru DirectoryServer control-script
ha node CLA-1 ru DirectoryServer process
ha node CLA-1 ru DirectoryServer process .rule
ha node CLA-1 ru DirectoryServer process LDAPServer
ha node CLA-1 ru DirectoryServer process LDAPServer
.instanceof
ha node CLA-1 ru DirectoryServer process LDAPServer
.instanceof \

fs.ha.process

ha node CLA-1 ru DirectoryServer process LDAPServer
.instanceof \

fs.ha.process.LDAPServer

ha node CLA-1 ru DirectoryServer process LDAPServer .rule
ha node CLA-1 ru DirectoryServer rg
ha node CLA-1 ru DirectoryServer rg Directory
ha node CLA-1 ru FooServer
ha node CLA-1 ru FooServer .instanceof
ha node CLA-1 ru FooServer .instanceof fs.ha.ru
ha node CLA-1 ru FooServer .instanceof fs.ha.ru.FooServer
ha node CLA-1 ru FooServer .rule
ha node CLA-1 ru FooServer control-script
ha node CLA-1 ru FooServer control-script \

/opt/nokiasiemens/SS_Foo/script/FooServerControl.sh

ha node CLA-1 ru FooServer process
ha node CLA-1 ru FooServer process .rule
ha node CLA-1 ru FooServer process Bar
ha node CLA-1 ru FooServer process Bar .instanceof
ha node CLA-1 ru FooServer process Bar .instanceof
fs.ha.process
ha node CLA-1 ru FooServer process Bar .instanceof
fs.ha.process.Bar
ha node CLA-1 ru FooServer process Bar .rule
ha node CLA-1 ru FooServer process Foo
ha node CLA-1 ru FooServer process Foo .instanceof
ha node CLA-1 ru FooServer process Foo .instanceof
fs.ha.process
ha node CLA-1 ru FooServer process Foo .instanceof
fs.ha.process.Foo
ha node CLA-1 ru FooServer process Foo .rule
ha node CLA-1 ru FooServer rg
ha node CLA-1 ru FooServer rg Foo
ha rg
ha rg .rule
ha rg Directory
ha rg Directory .instanceof
ha rg Directory .instanceof fs.ha.rg
ha rg Directory .instanceof fs.ha.rg.Directory
ha rg Directory .instanceof fs.ha.rg.activestdby
ha rg Directory .instanceof fs.ha.rg.coldactivestdby
ha rg Directory .rule
ha rg Directory ru
ha rg Directory ru node CLA-0 ru DirectoryServer
ha rg Directory ru node CLA-1 ru DirectoryServer
ha rg Foo
ha rg Foo .instanceof
ha rg Foo .instanceof fs.ha.rg
ha rg Foo .instanceof fs.ha.rg.Foo
ha rg Foo .instanceof fs.ha.rg.nonredundant
ha rg Foo .rule
ha rg Foo ru
ha rg Foo ru node CLA-0 ru FooServer
ha rg Foo ru node CLA-1 ru FooServer

Implied objects, also underlined in italics in the listing, are created according to the rule, substituting the node name (CLA-0, CLA-1) for the regex group reference {n_{—}1}. Here {n_{—}1} refers to the first group of selector n. The groups are marked with parentheses. When object CLA-0 .instanceof fs.ha.node.supervised (in subtree ha node) matches ([̂]+) .instanceof fs.ha.node.supervised, {n_{—}1} evaluates to CLA-0 when processing the object declarations. For example, .{n_{—}1} ru FooServer evaluates to .CLA-0 ru FooServer. The corresponding absolute path would be ha node CLA-0 ru FooServer. Creation of those objects results in processing the implied object declarations of the fs.ha.ru.FooServer class, in a similar fashion as illustrated by Listing 4.

Listing 4 demonstrates how the database portion in Listing 3 is updated upon object creation:

ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed
ha node CLA-0 .instanceof fs.ha.node.supervised
ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \

fs.ha.process

ha node CLA-0 ru DirectoryServer process LDAPServer
.instanceof \

fs.ha.process.LDAPServer

ha node CLA-0 ru DirectoryServer process LDAPServer .rule
ha node CLA-0 ru DirectoryServer rg
ha node CLA-0 ru DirectoryServer rg Directory
ha node CLA-0 ru FooServer
ha node CLA-0 ru FooServer .instanceof
ha node CLA-0 ru FooServer .instanceof fs.ha.ru
ha node CLA-0 ru FooServer .instanceof fs.ha.ru.FooServer
ha node CLA-0 ru FooServer .rule
ha node CLA-0 ru FooServer control-script
ha node CLA-0 ru FooServer control-script \

/opt/nokiasiemens/SS_Foo/script/FooServerControl.sh

ha node CLA-0 ru FooServer process
ha node CLA-0 ru FooServer process .rule
ha node CLA-0 ru FooServer process Bar
ha node CLA-0 ru FooServer process Bar .instanceof
ha node CLA-0 ru FooServer process Bar .instanceof
fs.ha.process
ha node CLA-0 ru FooServer process Bar .instanceof
fs.ha.process.Bar
ha node CLA-0 ru FooServer process Bar .rule
ha node CLA-0 ru FooServer process Foo
ha node CLA-0 ru FooServer process Foo .instanceof
ha node CLA-0 ru FooServer process Foo .instanceof
fs.ha.process
ha node CLA-0 ru FooServer process Foo .instanceof
fs.ha.process.Foo
ha node CLA-0 ru FooServer process Foo .rule
ha node CLA-0 ru FooServer rg

Note that in the previous example, the recovery group object is also created by the rule. It may as well be created directly by an implied object declaration, but now the creation is postponed until the first fs.ha.node.supervised subordinate appears.

Listing 8 shows how the database shown in Listing 7 is updated when the operator creates a new payload node object (fs.ha.node.payload) named AS-0. Due to the fact that the payload node class is derived from the fs.ha.node.supervised class, new match objects are created, resulting in creation of a new fs.ha.ru.FooServer instance under ha node AS-0 ru, and its linking to ha rg Foo. Listing 8 demonstrates how the database in Listing 7 is updated upon further object creation (while the definition of Listing 5 is in effect):

.rule
feature
feature .instanceof
feature .instanceof fs.feature
feature .instanceof fs.feature.root
feature .rule
feature Foo
feature Foo .instanceof
feature Foo .instanceof fs.feature
feature Foo .instanceof fs.feature.Foo
feature Foo .rule
ha
ha .rule
ha node
ha node .rule
ha node .rule feature-Foo
ha node .rule feature-Foo .match
ha node .rule feature-Foo .match 1
ha node .rule feature-Foo .match 3
ha node .rule feature-Foo .match 9
ha node .rule feature-Foo imply
ha node .rule feature-Foo imply 0
ha node .rule feature-Foo imply 0 .match
ha node .rule feature-Foo imply 0 .match 10
ha node .rule feature-Foo imply 0 .match 4
ha node .rule feature-Foo imply 0 .match 5
ha node .rule feature-Foo imply 0 object
ha node .rule feature-Foo imply 0 object Foo type
fs.ha.rg.Foo
ha node .rule feature-Foo imply 0 target
ha node .rule feature-Foo imply 0 target ha rg
ha node .rule feature-Foo imply 1
ha node .rule feature-Foo imply 1 .match
ha node .rule feature-Foo imply 1 .match 11
ha node .rule feature-Foo imply 1 .match 6
ha node .rule feature-Foo imply 1 .match 7
ha node .rule feature-Foo imply 1 object
ha node .rule feature-Foo imply 1 object FooServer type \

fs.ha.ru FooServer rg Foo

ha node .rule feature-Foo imply 1 target
ha node .rule feature-Foo imply 1 target . {n_1} ru
ha node .rule feature-Foo selector
ha node .rule feature-Foo selector n
ha node .rule feature-Foo selector n .match
ha node .rule feature-Foo selector n .match 0
ha node .rule feature-Foo selector n .match 2
ha node .rule feature-Foo selector n .match 8
ha node .rule feature-Foo selector n pattern
ha node .rule feature-Foo selector n pattern ([\hat{ } ]+)
.instanceof \

fs.ha.node.supervised

ha node AS-0
ha node AS-0 .instanceof
ha node AS-0 .instanceof fs.ha.node
ha node AS-0 .instanceof fs.ha.node.managed
ha node AS-0 .instanceof fs.ha.node.payload

[symbol]

ha node AS-0 .rule
ha node AS-0 ru
ha node AS-0 ru .rule
ha node AS-0 ru FooServer
ha node AS-0 ru FooServer .instanceof
ha node AS-0 ru FooServer .instanceof fs.ha.ru
ha node AS-0 ru FooServer .instanceof fs.ha.ru.FooServer
ha node AS-0 ru FooServer .rule
ha node AS-0 ru FooServer control-script
ha node AS-0 ru FooServer control-script \

/opt/nokiasiemens/SS_Foo/script/FooServerControl.sh

ha node AS-0 ru FooServer process
ha node AS-0 ru FooServer process .rule
ha node AS-0 ru FooServer process Bar
ha node AS-0 ru FooServer process Bar .instanceof
ha node AS-0 ru FooServer process Bar .instanceof
fs.ha.process
ha node AS-0 ru FooServer process Bar .instanceof
fs.ha.process.Bar
ha node AS-0 ru FooServer process Bar .rule
ha node AS-0 ru FooServer process Foo
ha node AS-0 ru FooServer process Foo .instanceof
ha node AS-0 ru FooServer process Foo .instanceof
fs.ha.process
ha node AS-0 ru FooServer process Foo .instanceof
fs.ha.process.Foo
ha node AS-0 ru FooServer process Foo .rule
ha node AS-0 ru FooServer rg
ha node AS-0 ru FooServer rg Foo
ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed
ha node CLA-0 .instanceof fs.ha.node.supervised
ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \

fs.ha.process

ha node CLA-0 ru DirectoryServer process LDAPServer
.instanceof \

fs.ha.process.LDAPServer

ha node CLA-0 ru DirectoryServer process LDAPServer .rule
ha node CLA-0 ru DirectoryServer rg
ha node CLA-0 ru DirectoryServer rg Directory
ha node CLA-0 ru FooServer
ha node CLA-0 ru FooServer .instanceof
ha node CLA-0 ru FooServer .instanceof fs.ha.ru
ha node CLA-0 ru FooServer .instanceof fs.ha.ru.FooServer
ha node CLA-0 ru FooServer .rule
ha node CLA-0 ru FooServer control-script
ha node CLA-0 ru FooServer control-script \

/opt/nokiasiemens/SS_Foo/script/FooServerControl.sh

ha node CLA-0 ru FooServer process
ha node CLA-0 ru FooServer process .rule
ha node CLA-0 ru FooServer process Bar
ha node CLA-0 ru FooServer process Bar .instanceof
ha node CLA-0 ru FooServer process Bar .instanceof
fs.ha.process
ha node CLA-0 ru FooServer process Bar .instanceof
fs.ha.process.Bar
ha node CLA-0 ru FooServer process Bar .rule
ha node CLA-0 ru FooServer process Foo
ha node CLA-0 ru FooServer process Foo .instanceof
ha node CLA-0 ru FooServer process Foo .instanceof
fs.ha.process
ha node CLA-0 ru FooServer process Foo .instanceof
fs.ha.process. Foo
ha node CLA-0 ru FooServer process Foo .rule
ha node CLA-0 ru FooServer rg
ha node CLA-0 ru FooServer rg Foo
ha node CLA-1
ha node CLA-1 .instanceof
ha node CLA-1 .instanceof fs.ha.node
ha node CLA-1 .instanceof fs.ha.node.cla
ha node CLA-1 .instanceof fs.ha.node.managed
ha node CLA-1 .instanceof fs.ha.node.supervised
ha node CLA-1 .rule
ha node CLA-1 ru
ha node CLA-1 ru .rule
ha node CLA-1 ru DirectoryServer
ha node CLA-1 ru DirectoryServer .instanceof
ha node CLA-1 ru DirectoryServer .instanceof fs.ha.ru
ha node CLA-1 ru DirectoryServer .instanceof
fs.ha.ru.DirectoryServer
ha node CLA-1 ru DirectoryServer .rule
ha node CLA-1 ru DirectoryServer control-script
ha node CLA-1 ru DirectoryServer process
ha node CLA-1 ru DirectoryServer process .rule
ha node CLA-1 ru DirectoryServer process LDAPServer
ha node CLA-1 ru DirectoryServer process LDAPServer
.instanceof
ha node CLA-1 ru DirectoryServer process LDAPServer
.instanceof \

fs.ha.process

ha node CLA-1 ru DirectoryServer process LDAPServer
.instanceof \

fs.ha.process.LDAPServer

ha node CLA-1 ru DirectoryServer process LDAPServer .rule
ha node CLA-1 ru DirectoryServer rg
ha node CLA-1 ru DirectoryServer rg Directory
ha node CLA-1 ru FooServer
ha node CLA-1 ru FooServer .instanceof
ha node CLA-1 ru FooServer .instanceof fs.ha.ru
ha node CLA-1 ru FooServer .instanceof fs.ha.ru.FooServer
ha node CLA-1 ru FooServer .rule
ha node CLA-1 ru FooServer control-script
ha node CLA-1 ru FooServer control-script \

/opt/nokiasiemens/SS_Foo/script/FooServerControl.sh

ha node CLA-1 ru FooServer process
ha node CLA-1 ru FooServer process .rule
ha node CLA-1 ru FooServer process Bar
ha node CLA-1 ru FooServer process Bar .instanceof
ha node CLA-1 ru FooServer process Bar .instanceof
fs.ha.process
ha node CLA-1 ru FooServer process Bar .instanceof
fs.ha.process.Bar
ha node CLA-1 ru FooServer process Bar .rule
ha node CLA-1 ru FooServer process Foo
ha node CLA-1 ru FooServer process Foo .instanceof
ha node CLA-1 ru FooServer process Foo .instanceof
fs.ha.process
ha node CLA-1 ru FooServer process Foo .instanceof
fs.ha.process.Foo
ha node CLA-1 ru FooServer process Foo .rule
ha node CLA-1 ru FooServer rg
ha node CLA-1 ru FooServer rg Foo
ha rg
ha rg .rule
ha rg Directory
ha rg Directory .instanceof
ha rg Directory .instanceof fs.ha.rg
ha rg Directory .instanceof fs.ha.rg.Directory
ha rg Directory .instanceof fs.ha.rg.activestdby
ha rg Directory .instanceof fs.ha.rg.coldactivestdby
ha rg Directory .rule
ha rg Directory ru
ha rg Directory ru node CLA-0 ru DirectoryServer
ha rg Directory ru node CLA-1 ru DirectoryServer
ha rg Foo
ha rg Foo .instanceof
ha rg Foo .instanceof fs.ha.rg
ha rg Foo .instanceof fs.ha.rg.Foo
ha rg Foo .instanceof fs.ha.rg.nonredundant
ha rg Foo .rule
ha rg Foo ru
ha rg Foo ru node AS-0 ru FooServer
ha rg Foo ru node CLA-0 ru FooServer
ha rg Foo ru node CLA-1 ru FooServer

The rule definition shown in Listing 5 features only one selector. Rules with more elaborate triggering conditions may be defined by using multiple selectors, and formula and condition expressions.

Listing 9 shows what happens when the operator deletes object ha node CLA-1 when the database is in the state shown in Listing 8. The objects underlined in boldface (or underlined in boldface italics) will be deleted. Listing 9 demonstrates how the database in Listing 8 is updated upon object deletion:

```
.rule
feature
feature .instanceof
feature .instanceof fs.feature
feature .instanceof fs.feature.root
feature .rule
feature Foo
feature Foo .instanceof
feature Foo .instanceof fs.feature
feature Foo .instanceof fs.feature.Foo
feature Foo .rule
ha
ha .rule
ha node
ha node .rule
ha node .rule feature-Foo
ha node .rule feature-Foo .match
ha node .rule feature-Foo .match 1
ha node .rule feature-Foo .match 3
ha node .rule feature-Foo .match 9
ha node .rule feature-Foo imply
ha node .rule feature-Foo imply 0
ha node .rule feature-Foo imply 0 .match
ha node .rule feature-Foo imply 0 .match 10
ha node .rule feature-Foo imply 0 .match 4
ha node .rule feature-Foo imply 0 .match 5
ha node .rule feature-Foo imply 0 object
ha node .rule feature-Foo imply 0 object Foo type
fs.ha.rg.Foo
ha node .rule feature-Foo imply 0 target
ha node .rule feature-Foo imply 0 target ha rg
ha node .rule feature-Foo imply 1
ha node .rule feature-Foo imply 1 .match
ha node .rule feature-Foo imply 1 .match 11
ha node .rule feature-Foo imply 1 .match 6
ha node .rule feature-Foo imply 1 .match 7
ha node .rule feature-Foo imply 1 object
ha node .rule feature-Foo imply 1 object FooServer type \
fs.ha.ru.FooServer rg Foo
ha node .rule feature-Foo imply 1 target
ha node .rule feature-Foo imply 1 target . {n_1} ru
ha node .rule feature-Foo selector
ha node .rule feature-Foo selector n
ha node .rule feature-Foo selector n .match
ha node .rule feature-Foo selector n .match 0
ha node .rule feature-Foo selector n .match 2
ha node .rule feature-Foo selector n .match 8
ha node .rule feature-Foo selector n pattern
ha node .rule feature-Foo selector n pattern ([\hat{ } ]+)
.instanceof \
fs.ha.node.supervised
ha node AS-0
ha node AS-0 .instanceof
ha node AS-0 .instanceof fs.ha.node
ha node AS-0 .instanceof fs.ha.node.managed
ha node AS-0 .instanceof fs.ha.node.payload
ha node AS-0 .instanceof fs.ha.node.supervised
ha node AS-0 .rule
ha node AS-0 ru
ha node AS-0 ru .rule
ha node AS-0 ru FooServer
ha node AS-0 ru FooServer .instanceof
ha node AS-0 ru FooServer .instanceof fs.ha.ru
ha node AS-0 ru FooServer .instanceof fs.ha.ru.FooServer
ha node AS-0 ru FooServer .rule
ha node AS-0 ru FooServer control-script
ha node AS-0 ru FooServer control-script \
/opt/nokiasiemens/SS_Foo/script/FooServerControl.sh
ha node AS-0 ru FooServer process
ha node AS-0 ru FooServer process .rule
ha node AS-0 ru FooServer process Bar
ha node AS-0 ru FooServer process Bar .instanceof
ha node AS-0 ru FooServer process Bar .instanceof
fs.ha.process
ha node AS-0 ru FooServer process Bar .instanceof
fs.ha.process.Bar
ha node AS-0 ru FooServer process Bar .rule
ha node AS-0 ru FooServer process Foo
ha node AS-0 ru FooServer process Foo .instanceof
ha node AS-0 ru FooServer process Foo .instanceof
fs.ha.process
ha node AS-0 ru FooServer process Foo .instanceof
fs.ha.process.Foo
ha node AS-0 ru FooServer process Foo .rule
ha node AS-0 ru FooServer rg
ha node AS-0 ru FooServer rg Foo
ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed
ha node CLA-0 .instanceof fs.ha.node.supervised
ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \
fs.ha.process
ha node CLA-0 ru DirectoryServer process LDAPServer
.instanceof \
fs.ha.process.LDAPServer
ha node CLA-0 ru DirectoryServer process LDAPServer .rule
ha node CLA-0 ru DirectoryServer rg
ha node CLA-0 ru DirectoryServer rg Directory
ha node CLA-0 ru FooServer
ha node CLA-0 ru FooServer .instanceof
ha node CLA-0 ru FooServer .instanceof fs.ha.ru
ha node CLA-0 ru FooServer .instanceof fs.ha.ru.FooServer
ha node CLA-0 ru FooServer .rule
ha node CLA-0 ru FooServer control-script
ha node CLA-0 ru FooServer control-script \
/opt/nokiasiemens/SS_Foo/script/FooServerControl.sh
ha node CLA-0 ru FooServer process
ha node CLA-0 ru FooServer process .rule
ha node CLA-0 ru FooServer process Bar
ha node CLA-0 ru FooServer process Bar .instanceof
ha node CLA-0 ru FooServer process Bar .instanceof
fs.ha.process
ha node CLA-0 ru FooServer process Bar .instanceof
fs.ha.process.Bar
ha node CLA-0 ru FooServer process Bar .rule
ha node CLA-0 ru FooServer process Foo
ha node CLA-0 ru FooServer process Foo .instanceof
ha node CLA-0 ru FooServer process Foo .instanceof
fs.ha.process
ha node CLA-0 ru FooServer process Foo .instanceof
fs.ha.process.Foo
ha node CLA-0 ru FooServer process Foo .rule
ha node CLA-0 ru FooServer rg
ha node CLA-0 ru FooServer rg Foo

[symbol]

ha node CLA-1 .instanceof
ha node CLA-1 .instanceof fs.ha.node
ha node CLA-1 .instanceof fs.ha.node.cla
ha node CLA-1 .instanceof fs.ha.node.managed
ha node CLA-1 .instanceof fs.ha.node.supervised
ha node CLA-1 .rule
ha node CLA-1 ru
ha node CLA-1 ru .rule
ha node CLA-1 ru DirectoryServer
ha node CLA-1 ru DirectoryServer .instanceof
ha node CLA-1 ru DirectoryServer .instanceof fs.ha.ru
ha node CLA-1 ru DirectoryServer .instanceof \
    fs.ha.ru.DirectoryServer
ha node CLA-1 ru DirectoryServer .rule
ha node CLA-1 ru DirectoryServer control-script
ha node CLA-1 ru DirectoryServer process
ha node CLA-1 ru DirectoryServer process .rule
ha node CLA-1 ru DirectoryServer process LDAPServer
ha node CLA-1 ru DirectoryServer process LDAPServer
.instanceof
ha node CLA-1 ru DirectoryServer process LDAPServer
.instanceof \
    fs.ha.process
ha node CLA-1 ru DirectoryServer process LDAPServer
.instanceof \
    fs.ha.process.LDAPServer
ha node CLA-1 ru DirectoryServer process LDAPServer .rule
ha node CLA-1 ru DirectoryServer rg
ha node CLA-1 ru DirectoryServer rg Directory
ha node CLA-1 ru FooServer
ha node CLA-1 ru FooServer .instanceof
ha node CLA-1 ru FooServer .instanceof fs.ha.ru
ha node CLA-1 ru FooServer .instanceof fs.ha.ru.FooServer
ha node CLA-1 ru FooServer .rule
ha node CLA-1 ru FooServer control-script
ha node CLA-1 ru FooServer control-script \
    /opt/nokiasiemens/SS_Foo/script/FooServerControl.sh
ha node CLA-1 ru FooServer process
ha node CLA-1 ru FooServer process .rule
ha node CLA-1 ru FooServer process Bar
ha node CLA-1 ru FooServer process Bar .instanceof
ha node CLA-1 ru FooServer process Bar .instanceof
fs.ha.process
ha node CLA-1 ru FooServer process Bar .instanceof \
    fs.ha.process.Bar
ha node CLA-1 ru FooServer process Bar .rule
ha node CLA-1 ru FooServer process Foo
ha node CLA-1 ru FooServer process Foo .instanceof
ha node CLA-1 ru FooServer process Foo .instanceof
fs.ha.process
ha node CLA-1 ru FooServer process Foo .instanceof \
    fs.ha.process.Foo
ha node CLA-1 ru FooServer process Foo .rule
ha node CLA-1 ru FooServer rg
ha node CLA-1 ru FooServer rg Foo
ha rg
ha rg .rule
ha rg Directory
ha rg Directory .instanceof
ha rg Directory .instanceof fs.ha.rg
ha rg Directory .instanceof fs.ha.rg.Directory
ha rg Directory .instanceof fs.ha.rg.activestdby
ha rg Directory .instanceof fs.ha.rg.coldactivestdby
ha rg Directory .rule
ha rg Directory ru
ha rg Directory ru node CLA-0 ru DirectoryServer
ha rg Directory ru node CLA-1 ru DirectoryServer
ha rg Foo
ha rg Foo .instanceof
ha rg Foo .instanceof fs.ha.rg
ha rg Foo .instanceof fs.ha.rg.Foo
ha rg Foo .instanceof fs.ha.rg.nonredundant
ha rg Foo .rule
ha rg Foo ru
ha rg Foo ru node AS-0 ru FooServer
ha rg Foo ru node CLA-0 ru FooServer
ha rg Foo ru node CLA-1 ru FooServer
```

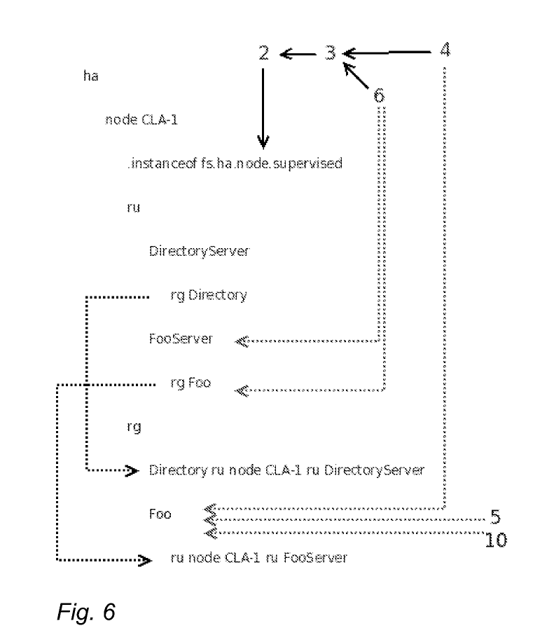

FIG. 6 displays relevant dependencies that are in effect in the beginning of the operation. FIG. 6 shows dependencies affecting the operation illustrated by Listing 9. Objects that are to be deleted are underlined in boldface (or underlined in boldface italics) in Listing 9. DEPENDS_ON dependencies are indicated in FIG. 6 by solid arrows, the object being pointed. Dashed arrows pointing to the right indicate USES dependencies. Dashed arrows pointing to the left indicate that there is both a USES and a REQUIRES dependency between the objects. The numbers in FIG. 6 represent match objects. In addition to ha node CLA-1 and its subordinates, the following objects are also deleted:
match objects related to the subordinate objects due to their DEPENDS_ON dependencies, and
reference assignments due to depletion of USES dependencies.

Object ha rg Foo is not deleted, since there are still some USES dependencies left. Note that in this example, the objects created by the rules happened to reside within the subtree which was deleted and contained the triggering objects. However, as is evident from FIG. 6, the dependencies are set up so that the garbage collection system can find the implied objects located anywhere in the configuration data when the triggering objects vanish.

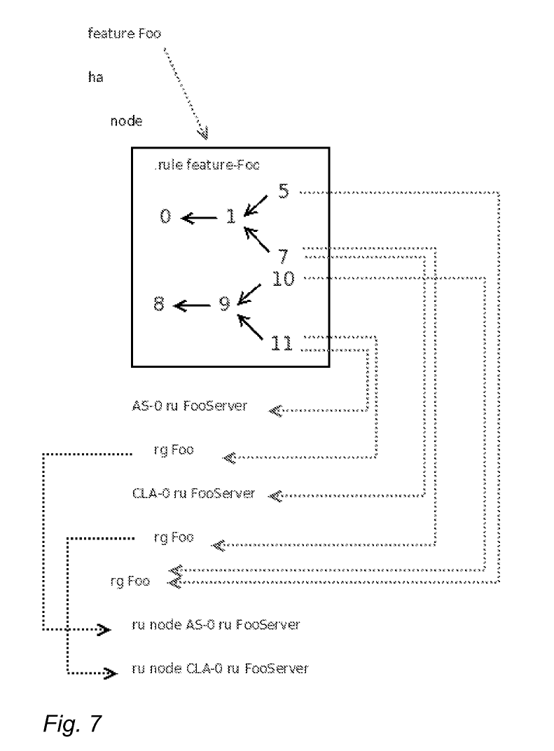

Listing 10 shows what happens when object feature Foo is deleted when the database is in the state shown in Listing 9 (excluding the objects marked in blue). Relevant existing dependencies are shown in FIG. 7, wherein FIG. 7 shows dependencies affecting the operation illustrated by Listing 10. The box around the rule and match objects in FIG. 7 indicates that the match objects belong to the rule's sub-tree. DEPENDS_ON dependencies are indicated in FIG. 7 by solid arrows, the object being pointed. Dashed arrows pointing to the right indicate USES dependencies. Dashed arrows pointing to the left (or downwards “in five o'clock direction”) indicate that there is both a USES and a REQUIRES dependency between the objects. In addition to the main object and its subordinates, the following objects are deleted with their subordinates due to USES dependency depletion: the rule deploying feature Foo, all FooServer recovery units, and the Foo recovery group. Listing 10 demonstrates how the database in Listing 9 is updated upon further object deletion:

```
.rule
feature
feature .instanceof
feature .instanceof fs.feature
feature .instanceof fs.feature.root
feature .rule

[symbol]

feature Foo .instanceof
feature Foo .instanceof fs.feature
feature Foo .instanceof fs.feature.Foo
feature Foo .rule
ha
ha .rule
ha node
ha node .rule
ha node .rule feature-Foo
ha node .rule feature-Foo .match
ha node .rule feature-Foo .match 1
ha node .rule feature-Foo .match 9
ha node .rule feature-Foo imply
ha node .rule feature-Foo impl 0
ha node .rule feature-Foo imply 0 .match
ha node .rule feature-Foo imply 0 .match 10
ha node .rule feature-Foo imply 0 .match 5
ha node .rule feature-Foo imply 0 object
ha node .rule feature-Foo imply 0 object Foo type
fs.ha.rg.Foo
ha node .rule feature-Foo imply 0 target
ha node .rule feature-Foo imply 0 target ha rg
ha node .rule feature-Foo imply 1
ha node .rule feature-Foo imply 1 .match
ha node .rule feature-Foo imply 1 .match 11
ha node .rule feature-Foo imply 1 .match 7
ha node .rule feature-Foo imply 1 object
ha node .rule feature-Foo imply 1 object FooServer type \
    fs.ha.ru.FooServer rg Foo
ha node .rule feature-Foo imply 1 target
ha node .rule feature-Foo imply 1 target . {n_1} ru
ha node .rule feature-Foo selector
ha node .rule feature-Foo selector n
ha node .rule feature-Foo selector n .match
ha node .rule feature-Foo selector n .match 0
ha node .rule feature-Foo selector n .match 8
ha node .rule feature-Foo selector n pattern
ha node .rule feature-Foo selector n pattern ([\hat{ }]+)
.instanceof \
    fs.ha.node.supervised
ha node AS-0
ha node AS-0 .instanceof
ha node AS-0 .instanceof fs.ha.node
ha node AS-0 .instanceof fs.ha.node.managed
ha node AS-0 .instanceof fs.ha.node.payload
ha node AS-0 .instanceof fs.ha.node.supervised
ha node AS-0 .rule
ha node AS-0 ru
ha node AS-0 ru .rule
ha node AS-0 ru FooServer
ha node AS-0 ru FooServer .instanceof
ha node AS-0 ru FooServer .instanceof fs.ha.ru
ha node AS-0 ru FooServer .instanceof fs.ha.ru.FooServer
ha node AS-0 ru FooServer .rule
ha node AS-0 ru FooServer control-script
ha node AS-0 ru FooServer control-script \
    /opt/nokiasiemens/SS_Foo/script/FooServerControl.sh
ha node AS-0 ru FooServer process
ha node AS-0 ru FooServer process .rule
ha node AS-0 ru FooServer process Bar
ha node AS-0 ru FooServer process Bar .instanceof
ha node AS-0 ru FooServer process Bar .instanceof
fs.ha.process
ha node AS-0 ru FooServer process Bar .instanceof \
    fs.ha.process.Bar
ha node AS-0 ru FooServer process Bar .rule
ha node AS-0 ru FooServer process Foo
ha node AS-0 ru FooServer process Foo .instanceof
ha node AS-0 ru FooServer process Foo .instanceof
fs.ha.process
ha node AS-0 ru FooServer process Foo .instanceof \
    fs.ha.process.Foo
ha node AS-0 ru FooServer process Foo .rule
ha node AS-0 ru FooServer rg
ha node AS-0 ru FooServer rg Foo
ha node CLA-0
ha node CLA-0 .instanceof
ha node CLA-0 .instanceof fs.ha.node
ha node CLA-0 .instanceof fs.ha.node.cla
ha node CLA-0 .instanceof fs.ha.node.managed
ha node CLA-0 .instanceof fs.ha.node.supervised
ha node CLA-0 .rule
ha node CLA-0 ru
ha node CLA-0 ru .rule
ha node CLA-0 ru DirectoryServer
ha node CLA-0 ru DirectoryServer .instanceof
ha node CLA-0 ru DirectoryServer .instanceof fs.ha.ru
ha node CLA-0 ru DirectoryServer .instanceof
fs.ha.ru.DirectoryServer
ha node CLA-0 ru DirectoryServer .rule
ha node CLA-0 ru DirectoryServer control-script
ha node CLA-0 ru DirectoryServer process
ha node CLA-0 ru DirectoryServer process .rule
ha node CLA-0 ru DirectoryServer process LDAPServer
ha node CLA-0 ru DirectoryServer process LDAPServer
.instanceof
ha node CLA-0 ru DirectoryServer process LDAPServer
.instanceof \
    fs.ha.process
ha node CLA-0 ru DirectoryServer process LDAPServer
.instanceof \
    fs.ha.process.LDAPServer
ha node CLA-0 ru DirectoryServer process LDAPServer .rule
ha node CLA-0 ru DirectoryServer rg
ha node CLA-0 ru DirectoryServer rg Directory
ha node CLA-0 ru  FooServer
ha node CLA-0 ru FooServer .instanceof
ha node CLA-0 ru FooServer .instanceof fs.ha.ru
ha node CLA-0 ru FooServer .instanceof fs.ha.ru.FooServer
ha node CLA-0 ru FooServer .rule
ha node CLA-0 ru FooServer .instanceof control-script
ha node CLA-0 ru FooServer .instanceof control-script \
    /opt/nokiasiemens/SS Foo/script/FooServerControl.sh
ha node CLA-0 ru FooServer process
ha node CLA-0 ru FooServer process .rule
ha node CLA-0 ru FooServer process Bar
ha node CLA-0 ru FooServer process Bar .instanceof
ha node CLA-0 ru FooServer process Bar .instanceof
fs.ha.process
ha node CLA-0 ru FooServer process Bar .instanceof \
    fs.ha.process.Bar
ha node CLA-0 ru FooServer process Bar .rule
ha node CLA-0 ru FooServer process Foo
ha node CLA-0 ru FooServer process Foo .instanceof
ha node CLA-0 ru FooServer process Foo .instanceof
fs.ha.process
ha node CLA-0 ru FooServer process Foo .instanceof \
    fs.ha.process.Foo
ha node CLA-0 ru FooServer process Foo .rule
ha node CLA-0 ru FooServer rg
ha node CLA-0 ru FooServer rg Foo
ha rg
ha rg .rule
ha rg Directory
ha rg Directory .instanceof
ha rg Directory .instanceof fs.ha.rg
ha rg Directory .instanceof fs.ha.rg.Directory
ha rg Directory .instanceof fs.ha.rg.activestdby
ha rg Directory .instanceof fs.ha.rg.coldactivestdby
ha rg Directory .rule
ha rg Directory ru
ha rg Directory ru node CLA-0 ru DirectoryServer
ha rg Foo
ha rg Foo .instanceof
ha rg Foo .instanceof fs.ha.rg
ha rg Foo .instanceof fs.ha.rg.Foo
ha rg Foo .instanceof fs.ha.rg.nonredundant
ha rg Foo .rule
ha rg Foo ru
ha rg Foo ru node AS-0 ru FooServer
ha rg Foo ru node CLA-0 ru FooServer
```

Listing 11 demonstrates how the definition shown in Listing 5 can be generalized to allow multiple features with similar deployment characteristics to utilize a common base type containing the actual rules. The final feature classes define parameters controlling the rules. The definition of feature Foo is equivalent to the one shown in Listing 5. The feature Zot is deployed similarly but recovery units are created only under objects of type fs.ha.node.cla. In this example, the rule actually generates another rule for an object located elsewhere in the configuration data. The outer rule is also an example of a rule featuring multiple selectors. However, as each selector matches a single-value attribute assignment, the cardinality of the Cartesian product over the individual selector matches always equals to one (when all matched attributes have been assigned). Hence in this case, only one instance of the inner rule is created per feature instance. The example in Listing 11 also shows a possible way to define an additional attribute type named identifier. Listing 11 presents two example feature definitions utilizing a generic base definition:

typedef identifier {

inherits string;
match “[A-Za-z_][A-Za-z_0-9]*”;

}
class fs.feature.hosted {

inherits fs.feature;
identifier node-type;
identifier rg;
identifier rg-type;
identifier ru;
identifier ru-type;
imply . .rule ru {

selector nt { pattern “node-type (.+)”; }
selector g { pattern “rg (.+)”; }
selector gt { pattern “rg-type (.+)”; }
selector u { pattern “ru (.+)”; }
selector ut { pattern “ru-type (.+)”; }
imply “ha node .rule feature-{_name}” {

selector n { pattern “([\hat{ } ]+) .instanceof

fs.ha.node.{nt_1}”; }

imply “ha rg {g_1}” { type “fs.ha.rg.{gt_1}”; };
imply “. {{n_1}} ru {u_1}” {

type “fs.ha.ru.{ut_1}”;
rg “{g_1}”;

}

}

}

}
class fs.feature.Foo {

inherits fs.feature.hosted;
node-type supervised;
rg Foo;
rg-type Foo;
ru FooServer;
ru-type FooServer;

}
class fs.feature.Zot {

inherits fs.feature.hosted;
node-type cla;
rg Zot;
rg-type Zot;
ru ZotServer;
ru-type ZotServer;

}

Listing 12 demonstrates how to use an indirect scope in a reference. The fs.ha.node class has a reference named hw, indicating the physical computer unit where the node resides.

It may be, though, that only a portion of the available processor cores have been allocated to the node. Therefore, there is a multi-value reference named core indicating which cores have been reserved for this particular node. The cores belong to a single physical computer unit. The scope of the core reference (. hw . . . ) constrains the possible targets under the sub-tree pointed by the hw reference. When the assignment of the hw reference is deleted, the garbage collection system removes the core references as well. If core was a binding reference, the operation would be declined if there were any core assignments in effect. Indirect references may be used also in implied object declarations to create objects under or relative to a subtree pointed to by a reference. Listing 12 presents an example object class definition featuring a reference with an indirect scope:

class fs.ha.node {

reference hw {

type fs.hw.computer;
scope hw;

}
reference core {

type fs.hw.core;
multivalue;
scope . hw ...;

}
...

}

The design of the exemplary configuration management device reduces the development effort, since there is no need to develop schema-specific plug-ins or configuration tools for expansion and validation. Rather, the CMS implements fully generic logic which is controlled by definitions embedded in the schema. Prior solutions allowed automatic creation of attribute assignments and subordinate objects based on object prototypes. However, the power of expression of the prototypes is limited by the schema-specific tool interpreting the definitions and is not easily extensible.

An exemplary embodiment generalizes the solution to allow:
creating objects anywhere in the configuration data, and utilizing the generic object class instantiation logic when doing so
creating objects of arbitrary types
assigning values to arbitrary attributes and references
postponing the aforementioned operations until specified conditions are met, and
implementation of complex configuration expansion logic by constructing reactive chains of rules.

If NE is built on top of a multi-purpose platform, there may be need to
extend the expansion logic provided by the platform and
impose constraints on configuration options of the platform part.

These things are difficult to do in an original prototype-based system but rather trivial in the embodiment, as long as the schema definition format allows splitting object class definitions to multiple files. Then it is easy to extend the platform schema with application-specific subordinate and implied object declarations. In those CMSs where expansion is based on schema-specific program logic for object creation and deletion, it is possible that as a result of a programming error, the deletion operation for a specific object is not exactly the inverse operation of the corresponding creation operation. As a result, the database may end up in an inconsistent state. The embodiment averts this problem by providing a fully generic deletion operation based on dependency tracking. In this design, the fully expanded set of configuration objects is a function of the high-level configuration and nothing else. The order of creation of the high-level objects or the past states of the configuration do not matter. The embodiment advantageously utilizes the dependency tracking system also
to implement configuration reduction by allowing the operator to extract the configuration as a series of high-level procedural operations without any schema-specific implementation, and
to facilitate schema upgrades.

Even though the exemplary configuration management device possesses some characteristics resembling the triggers, assertions, and referential integrity constraints of prior SQL databases, it has advantages over them. The garbage collection capabilities of SQL are limited to the ON DELETE CASCADE option for foreign keys. The embodiment features a real garbage collection system allowing dependencies from multiple objects and detecting circular dependencies. In SQL, it is also difficult to model hierarchical object structures or object class hierarchies, which is often necessary in practical NE configuration models. When an SQL assertion or other constraint fails, the database engine usually produces a generic error code, which has no meaning for the operator. Displaying meaningful error messages requires additional schema-specific program code. In the embodiment, it is possible to embed error messages to the implied object and rule definitions, such that the messages are displayed when an assertion or implied object creation fails. In the context of rules, these messages may have references to the selector and formula variables, rendering them even more useful.

The exemplary embodiment involves a network element configuration management system using a novel programming paradigm that addresses various disadvantages of prior comparable systems which require lots of application-specific program code to expand procedural configuration operations into a detailed object model. The improved system utilizes a generalized prototype system with multiple inheritance, allowing the configuration expansion and integrity checking logic to be expressed using special-purpose declarations in object prototype definitions, thus eliminating the need for partially redundant schema-specific program logic. The improved system also employs a versatile dependency tracking system in order to automatically provide referential integrity checking, garbage collection, and reduction to a series of procedural operations.

In an embodiment, configuration data and configuration objects are managed based on one or more predetermined conditions. The predetermined condition involves e.g. implied object declarations and rules. A rule specifies conditions (in the form of selectors and condition expression), and/or consequences (in the form of implied object declarations). Implied object declarations in a prototype definition are similar, except that the condition is simply the presence of an instance of that particular type.

In an embodiment, a path name is an indirect absolute or relative path name, the meaning of which depends on the reference assignments in the configuration database.

In an embodiment, one or more of the following properties may also be implemented: formulae, conditions, and assertions in rules; custom object selectors using a programming language (to be used in expressions); embedding error messages into schema definitions.

In an embodiment, CMS may also implement one or more of the following properties: persistent storage for configuration data, attribute types (other than string), ACLs for configuration objects, internal objects and attributes (not visible at external interfaces), network protocol for remote access, data replication to remote databases, high availability, API for reading and modifying the configuration data, API for listening to modification events, API for presenting system state via dynamic attributes, API for extending the object classes by custom methods.

In an embodiment, the set of detail-level objects is created based on the high-level objects according to pre-configured definitions. However, a detail-level object is not necessarily a subordinate object of an implying high-level object in the configuration data. A detail-level object may be created as a result of a combination of multiple other objects (but an object may not be a subordinate of more than one other object). A detail-level object can also be implied by another detail-level object or a combination of high-level and detail-level objects. It is also possible that a high-level object is a subordinate of a detail-level object, if the subordinate has been created after the object implying the superior detail-level object.

In an embodiment, the location of the objects created when processing rules is significant. Each object holds a DEPENDS_ON dependency to its superior, which reflects e.g. in the garbage collection process of rule-generated objects.

In an embodiment, if the rules cannot be extended in any way, the REQUIRES and USES dependencies may be created directly between the implied object and the group match object.

In an embodiment, the following processing logic may be applied:

condition=false, assertion=false: do nothing, since the rule does not apply;

condition=false, assertion=true: do nothing, since the rule does not apply;

condition=true, assertion=false: fail the transaction;

condition=true, assertion=true: continue processing the rule (implied object declarations).

Four possible modification operations for configuration objects are described: create, delete, flush, and set. Creation of an object may trigger rules to produce more objects. These objects may then trigger further rules to produce even more objects. Correspondingly, deletion of an object triggers garbage collection, potentially resulting in deletion of further objects. Flush is a generalization of deletion. The set operation may be used for attributes and references, and also for altering the name or primary class of an instance. The creation and deletion operations may have a recursive nature.

In an embodiment, there is provided a computer readable memory embodying a program of instructions executable by a processor to perform the method steps described above.

The steps, signalling messages and related functions described in FIGS. 1 to 7 are in no absolute chronological order, and some of the steps may be performed simultaneously or in an order differing from the given one. Other functions can also be executed between the steps or within the steps and other signalling messages sent between the illustrated messages. Some of the steps can also be left out or replaced with a corresponding step. The signalling messages are only exemplary and may even comprise several separate messages for transmitting the same information. In addition, the messages may also contain other information.

An apparatus able to perform the above-described steps may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to perform network element configuration management as described above.

The computer program may be in source code form, object code form, or in some intermediate form, and it may be stored in some sort of carrier, which may be any entity or device capable of carrying the program. Such carriers include a record medium, computer memory, read-only memory, an electrical carrier signal, a telecommunications signal, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus 800, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

ACL Access control list

AIS Application interface specification

AMF Availability management framework

API Application programming interface

CMS Configuration management system

HAS High availability services

IETF Internet engineering task force

LDAP Lightweight directory access protocol

NE Network element

NSN Nokia Siemens Networks

SAF Service Availability Forum

SQL Structured query language

XML Extensible mark-up language

XSL Extensible style-sheet language

XSLT XLS transformations

CLM Cluster Membership Service

1. A method for configuration management of a network element, the method comprising performing, in a network apparatus, the steps of
maintaining configuration data on the network element;
creating a set of configuration objects in the configuration data, wherein if a predetermined condition is satisfied, yet another configuration object is created in the configuration data;
if said yet another configuration object satisfies said predetermined condition or another predetermined condition, creating one or more further configuration objects in the configuration data;
storing dependency information in the configuration data on the configuration objects satisfying said predetermined condition or said another predetermined condition and on the configuration objects created based on said predetermined condition or said another predetermined condition.

2. A method of claim 1, wherein
the predetermined condition comprises a rule set up for the object configuration, the rule defining a dependency between one or more configuration objects and one or more further configuration objects; and
in response to the predetermined condition being met, processing the rule, wherein if said one or more configuration objects are altered in response to the processing, said one or more further configuration objects are altered according to the dependency defined in the rule.

3. A method of claim 1, further comprising expressing the predetermined condition as a special-purpose declaration in a configuration object prototype definition;
employing a dependency tracking system in order to automatically provide one or more of referential integrity checking, garbage collection, and reduction to a series of procedural operations.

4. A method of claim 1, further comprising
defining configuration data of a network element as a set of objects;
arranging the set of objects such that denoting an ownership relation between the objects is denoted, the objects having unique path names determining their position;
wherein the object is an instance of a specified object class, wherein a referenced object is specified by a respective path name.

5. A method of claim 1, wherein
the attributes, references, and assigned values thereof are represented as objects in the configuration data, having uniform path names with the other objects, wherein the assigned values of the attributes and references are encoded in the name of the value objects;
wherein the method comprises defining a configuration object class, the object class comprising a name uniquely identifying the object class, a declaration of subordinate objects, an ordered list of implied object declarations allowing configuration expansion by automatic creation of additional configuration objects, a reference to inherited object class definitions, and a flag indicating whether the object class is abstract.

6. A method of claim 1, wherein a subordinate configuration object declaration comprises the name of the configuration object and the type of the configuration object, including one or more of
an attribute,
an instance of a specified object class,
a reference to an instance or multiple instances of a specified object class, located in a specific position in the configuration data,
a set of instances of a specified object class, and
a container object grouping further attributes, instances, references, sets, and containers together;
wherein the attribute, reference, set, and the container subordinate are created automatically in response the instance object being created, and, if desired, the instance subordinates are created by implied configuration object declarations.

7. A method of claim 1, wherein it comprises employing configuration object dependency tracking, such that
a depends-on dependency implies that the subject of the dependency is deleted if the object of the dependency is deleted,
a uses dependency justifies the existence of the object of the dependency and prevents its deletion by automatic garbage collection as long as the subject of the dependency exists,
a requires dependency prevents deletion of the object of the dependency unless the subject of the dependency is deleted in the same transaction,
an exports dependency indicates that the object of the dependency has been created explicitly by the network operator, being part of high-level configuration of the network element, wherein the subject of the dependency is a root object;
wherein the method comprises implementing garbage collection based on the object dependencies, wherein a configuration object is automatically deleted when it is not possible to reach the configuration object by following the uses dependencies from the root object, and/or the object of a depends-on dependency of the configuration object is deleted;
wherein the method comprises performing a flush operation, the flush operation comprising deleting the subordinate objects of the target object in a single transaction, the subordinate objects being objects of export dependencies;
wherein the method comprises implementing configuration reduction based on the export dependency.

8. A method of claim 1, further comprising defining a rule, wherein the rule is a named object comprising subordinates of
a set of object selectors, wherein a selector comprises a pattern, against which object paths are matched and which optionally yields one or more variables accessible by formula, condition and assertion expressions, and optionally a name;
a set of formulas, wherein a formula comprises a name and an expression yielding a string-type variable accessible by condition and assertion expressions, and by object rules;
a condition, wherein the condition is a Boolean expression specifying whether the rule is valid for a set of selected objects;
an assertion, wherein the assertion is a Boolean expression;
a set of implied object declarations, the declarations comprising references to object selector and formula variables.

9. A method of claim 1, further comprising creating a match object under a selector, wherein a Cartesian product is calculated from the match object sets of other selectors of the rule, wherein each member of the product set is a vector of match objects and processed by
combining the variable assignments of the match objects of the vector with each other and with the assignments of the newly created match object;
evaluating the formula expressions, substituting the assigned values for selector variable references, wherein additional variable assignments are generated;
evaluating the condition expression, substituting the assigned values for selector and formula variable references;
creating a group match object under the rule object;
evaluating the assertion expression, substituting the assigned values for selector and formula variable references;
processing the implied object declarations of the rule, substituting the assigned values for variable references, wherein a special group match-specific object is created under the declaration object;
wherein the group match object stores combined variable assignments and those generated by the formulae, wherein, for each match object of the vector, a depends-on dependency is created, the group match object being the subject;
wherein the special group match-specific object holds a depends-on dependency to the group match object, and requires and uses dependencies to the implied object and optionally to the related attribute and reference assignments;
wherein the assertion yields the value of true for the sets of matched objects satisfying the condition, and the value of false for a failed transaction.

10. An apparatus configured to
maintain configuration data on a network element;
create a set of configuration objects in the configuration data, wherein if a predetermined condition is satisfied, the apparatus is configured to create yet another configuration object in the configuration data;
if said yet another configuration object satisfies said predetermined condition or another predetermined condition, the apparatus is configured to create one or more further configuration objects in the configuration data;
wherein the apparatus is configured to store dependency information in the configuration data on the configuration objects satisfying the said predetermined condition or said another predetermined condition and on the configuration objects created based on said predetermined condition or said another predetermined condition.

11. An apparatus of claim 10, wherein the predetermined condition comprises a rule set up for the object configuration, the rule defining a dependency between one or more configuration objects and one or more further configuration objects;
wherein the apparatus is further configured to, in response to a predetermined condition being met, process the rule, wherein if said one or more configuration objects are altered in response to the processing, said one or more further configuration objects are altered according to the dependency defined in the rule.

12. An apparatus of claim 10, wherein it is further configured to
express the predetermined condition as a special-purpose declaration in a configuration object prototype definition;
employ a dependency tracking system in order to automatically provide one or more of referential integrity checking, garbage collection, and reduction to a series of procedural operations;
describe a configuration management system at a relatively high level by using an object model;
perform configuration expansion by generating a detailed configuration based on high-level definitions.

13. An apparatus of claim 10, wherein it is further configured to
define configuration data of a network element as a set of objects;
arrange the set of objects such that an ownership relation between the objects is denoted, the objects having unique path names determining their position in the configuration data;
define the object as an instance of a specified object class, wherein a referenced object is located in the configuration data as specified by a respective path name.

14. An apparatus of claim 10, wherein it is further configured to
indicate, by using a flag, whether a reference is a binding reference, thus preventing the deletion of the reference target unless the reference assignment is itself deleted in a same transaction;
delete a non-binding reference automatically if the target object is deleted.

15. An apparatus of claim 10, wherein it is further configured to
when an instance is created, assign it a primary configuration object class, wherein the object is an instance of that class and also of the direct and indirect super-classes of that class;
determine the set of attributes usable with a specific object by a class of the object.

16. An apparatus of claim 10, wherein it is further configured to define that the configuration object represents a physical or logical entity in the network element, said entity including one or more of a hardware component, process, service, interface, address, and a database.

17. An apparatus of claim 10, wherein it is further configured to validate a proposed configuration, wherein if the configuration is to be altered in a way that the network element does not support and/or in a way that is semantically incorrect, the apparatus is further configured to decline the altering operation.

18. An apparatus of claim 10, wherein it is further configured to
define the attributes, references, and assigned values thereof to be represented as objects in the configuration data, having uniform path names with the other objects, wherein the assigned values of the attributes and references are encoded in the name of the value objects;
define a configuration object class, the object class comprising a name uniquely identifying the object class, a declaration of subordinate objects, an ordered list of implied object declarations allowing configuration expansion by automatic creation of additional configuration objects, a reference to inherited object class definitions, and a flag indicating whether the object class is abstract.

19. An apparatus of claim 10, wherein it is further configured to
define a subordinate configuration object declaration comprising the name of the configuration object and the type of the configuration object, including one or more of
an attribute,
an instance of a specified object class,
a reference to an instance or multiple instances of a specified object class, located in a specific position in the configuration data,
a set of instances of a specified object class, and
a container object grouping further attributes, instances, references, sets, and containers together;
wherein the apparatus is further configured to create the attribute, reference, set, and the container subordinate automatically in response the instance object being created, and, if desired, the apparatus is further configured to create the instance subordinates by implied configuration object declarations;
wherein the apparatus is further configured to, after processing of a rule, carry out a validity checking, whether required attributes and references have been assigned and whether the attribute assignments are semantically correct, to ensure consistency of a transaction.

20. An apparatus of claim 10, wherein the predetermined condition comprises an implied object such that the implied object comprises a configuration object located in the configuration data, the implied object being implied by a further configuration object located in the configuration data or by a combination of further configuration objects located in the configuration data.

21. An apparatus of claim 10, wherein it is further configured to define a path name as a sequence of object names indicating the position of the object in the configuration data, wherein an absolute path name indicates the position of the object relative to the root object, the absolute path name uniquely identifying the object, wherein a relative path name indicates the position of the object relative to another object, the meaning of the path name depending on the reference assignments in the configuration data.

22. An apparatus of claim 10, wherein it is further configured to employ configuration object dependency tracking, such that
a depends-on dependency implies that the subject of the dependency is deleted if the object of the dependency is deleted,
a uses dependency justifies the existence of the object of the dependency and prevents its deletion by automatic garbage collection as long as the subject of the dependency exists,
a requires dependency prevents deletion of the object of the dependency unless the subject of the dependency is deleted in the same transaction,
an exports dependency indicates that the object of the dependency has been created explicitly by the network operator, being part of high-level configuration of the network element, wherein the subject of the dependency is a root object;
wherein the apparatus is further configured to
implement garbage collection based on the object dependencies, wherein a configuration object is automatically deleted when it is not possible to reach the configuration object by following the uses dependencies from the root object, and/or the object of a depends-on dependency of the configuration object is deleted;
perform a flush operation, the flush operation comprising deleting the subordinate objects of the target object in a single transaction, the subordinate objects being objects of export dependencies;
implement configuration reduction based on the export dependency.

23. An apparatus of claim 10, wherein it is further configured to define a rule, wherein the rule is a named object comprising subordinates of
a set of object selectors, wherein a selector comprises a pattern, against which object paths are matched and which optionally yields one or more variables accessible by formula, condition and assertion expressions, and optionally a name;
a set of formulas, wherein a formula comprises a name and an expression yielding a string-type variable accessible by condition and assertion expressions, and by object rules;
a condition, wherein the condition is a Boolean expression specifying whether the rule is valid for a set of selected objects;
an assertion, wherein the assertion is a Boolean expression;
a set of implied object declarations, the declarations comprising references to object selector and formula variables.

24. An apparatus of claim 10, wherein it is further configured to create a match object under a selector, wherein a Cartesian product is calculated from the match object sets of other selectors of the rule, wherein each member of the product set is a vector of match objects and processed by
combining the variable assignments of the match objects of the vector with each other and with the assignments of the newly created match object;
evaluating the formula expressions, substituting the assigned values for selector variable references, wherein additional variable assignments are generated;
evaluating the condition expression, substituting the assigned values for selector and formula variable references;
creating a group match object under the rule object;
evaluating the assertion expression, substituting the assigned values for selector and formula variable references;
processing the implied object declarations of the rule, substituting the assigned values for variable references, wherein a special group match-specific object is created under the declaration object;
wherein the group match object stores combined variable assignments and those generated by the formulae, wherein, for each match object of the vector, a depends-on dependency is created, the group match object being the subject;
wherein the special group match-specific object holds a depends-on dependency to the group match object, and requires and uses dependencies to the implied object and optionally to the related attribute and reference assignments;
wherein that the assertion yields the value of true for the sets of matched objects satisfying the condition, and the value of false for a failed transaction.

25. An apparatus of claim 10, wherein it is further configured to, when a configuration object is created, match the configuration object against existing rules of its direct and indirect superior configuration objects, wherein, if needed, the apparatus is further configured to create new implied configuration objects.
